(19) United States
(12) Patent Application Publication
(10) Pub. No.: US 2019/0310524 A1
(43) Pub. Date: Oct. 10, 2019

(54) LIQUID CRYSTAL DISPLAY DEVICE AND METHOD OF PRODUCING LIQUID CRYSTAL DISPLAY DEVICE

(71) Applicant: SHARP KABUSHIKI KAISHA, Sakai City (JP)

(72) Inventors: HISASHI NAGATA, Sakai City (JP); YASUYOSHI KAISE, Sakai City (JP); JIN NAKAMURA, Sakai City (JP)

(21) Appl. No.: 16/380,577

(22) Filed: Apr. 10, 2019

(30) Foreign Application Priority Data
Apr. 10, 2018 (JP) 2018-075568

(51) Int. Cl. G02F 1/1337; G02F 1/137; G02F 1/1335; H04N 5/225

(52) U.S. Cl. CPC G02F 1/133753; G02F 1/137; G02F 1/133528; G02F 1/133723; G02F 1/133514; G02F 1/133512; G02F 2001/133738; H04N 5/2253

(57) ABSTRACT

The present invention provides a liquid crystal display device and a method of production thereof, each of which can prevent a camera image from being adversely affected by the birefringence of external polarized light which enters the camera through the liquid crystal layer. In a liquid crystal display device (1A), light to enter a camera (3) passes through a part of a liquid crystal panel (10A). Then, the liquid crystal panel (10A) is configured so that (i) a first part of the liquid crystal layer (14), which first part is located in the camera light transmissive region (S1) (through which the light to enter the camera (3) passes), has an isotropic refractive index and (ii) the second part of the liquid crystal layer (14), which part is located in the non-camera light transmissive region (S2) (which excludes the camera light transmissive region (S1)), has an anisotropic refractive index.

This Nonprovisional application claims priority under 35 U.S.C. § 119 on Patent Application No. 2018-075568 filed in Japan on Apr. 10, 2018, the entire contents of which are hereby incorporated by reference.

### TECHNICAL FIELD

The present invention relates to (i) a liquid crystal display device in which light to enter a camera passes through a part of a display section and (ii) a method of producing the liquid crystal display device.

### BACKGROUND ART

There are conventionally known liquid crystal display devices, in each of which a transmissive part for a camera is provided in a part of a display panel, in which part there are no pixels or no color filter.

For example, according to a display device disclosed in Patent Literature 1, (i) a transmissive hole is provided in a black matrix so that light passes through the transmissive hole and (ii) external light passes through the transmissive hole and a liquid crystal layer and then enters a camera.

According to the display device disclosed in Patent Literature 1, the occurrence of a diffraction phenomenon is prevented by the transmissive hole which is, for example, filled with a filler having a refractive index identical to that of a substrate.

### CITATION LIST

### Patent Literature

[Patent Literature 1]

Japanese Patent Application Publication, Tokukai, No. 2013-205840 (Publication Date: Oct. 7, 2013)

### SUMMARY OF INVENTION

### Technical Problem

According to a camera-embedded display panel into which light enters through a liquid crystal layer, the following problem occurs in a case where light entering the camera has a polarized light component (e.g., light reflected by a water surface): the birefringence in a part of the liquid crystal layer, which part corresponds to the transmissive part for the camera, leads to coloring or light-blocking of a camera image.

This is because the part of the liquid crystal layer, which part corresponds to the transmissive part for the camera, is subjected to an alignment process in a manner similar to a part of an active area where pixels are present, so that liquid crystal molecules are oriented in one direction also in the part. Consequently, in a case where light having a polarized light component passes through the liquid crystal molecules having a polarized light component as a result of an alignment process, the light then has an unnecessary birefringence effect.

The display device disclosed in Patent Literature 1 does not deal with such an adverse effect on a camera image caused by the birefringence of external light having a polarized light component.

The present invention has been made in view of the conventional problem, and it is an object of the present invention to provide a liquid crystal display device and a method of production thereof, each of which can prevent a camera image from being adversely affected by the birefringence of external polarized light which enters the camera through the liquid crystal layer.

### Solution to Problem

In order to attain the object, a liquid crystal display device in accordance with an aspect of the present invention is a liquid crystal display device including: a display section including a liquid crystal layer; and a camera, the liquid crystal display device being configured so that light to enter the camera passes through a part of the display section,

the liquid crystal layer of the display section having (a) a first part being located in a camera light transmissive region and having an isotropic refractive index, which camera light transmissive region allows the light to enter the camera to pass therethrough and (b) a second part being located in a non-camera light transmissive region and having an anisotropic refractive index, which non-camera light transmissive region excludes the camera light transmissive region.

In order to attain the object, a liquid crystal display device production method in accordance with an aspect of the present invention is a method of producing a liquid crystal display device, the liquid crystal display device including: a display section including a liquid crystal layer; and a camera, the liquid crystal display device being configured so that light to enter the camera passes through a part of the display section, the method including the steps of: (a) causing a first part of the liquid crystal layer of the display section, which first part is located in a camera light transmissive region allowing the light to enter the camera to pass therethrough, to have an isotropic refractive index; and (b) causing a second part of the liquid crystal layer of the display section, which second part is located in a non-camera light transmissive region excluding the camera light transmissive region, to have an anisotropic refractive index.

### Advantageous Effects of Invention

With an aspect of the present invention, it is advantageously possible to provide a liquid crystal display device and a method of production thereof, each of which can prevent a camera image from being adversely affected by the birefringence of external polarized light which enters the camera through the liquid crystal layer.

### BRIEF DESCRIPTION OF DRAWINGS

FIG. 1 is a cross-sectional view illustrating a configuration of a liquid crystal display device in accordance with Embodiment 1 of the present invention.

FIG. 2A is a front view illustrating a configuration of a liquid crystal panel of the liquid crystal display device. FIG. 2B is a front view illustrating a configuration of a variation of the liquid crystal panel of the liquid crystal display device.

FIG. 3 is a cross-sectional view illustrating an alignment function imparting process, in the liquid crystal display device, of causing, by use of optical alignment, an alignment film, to which an alignment function is not imparted, to become an alignment film to which an alignment function is imparted.

FIG. 4 is a cross-sectional view illustrating a configuration of a liquid crystal display device in accordance with Embodiment 2 of the present invention.

### DESCRIPTION OF EMBODIMENTS

### Embodiment 1

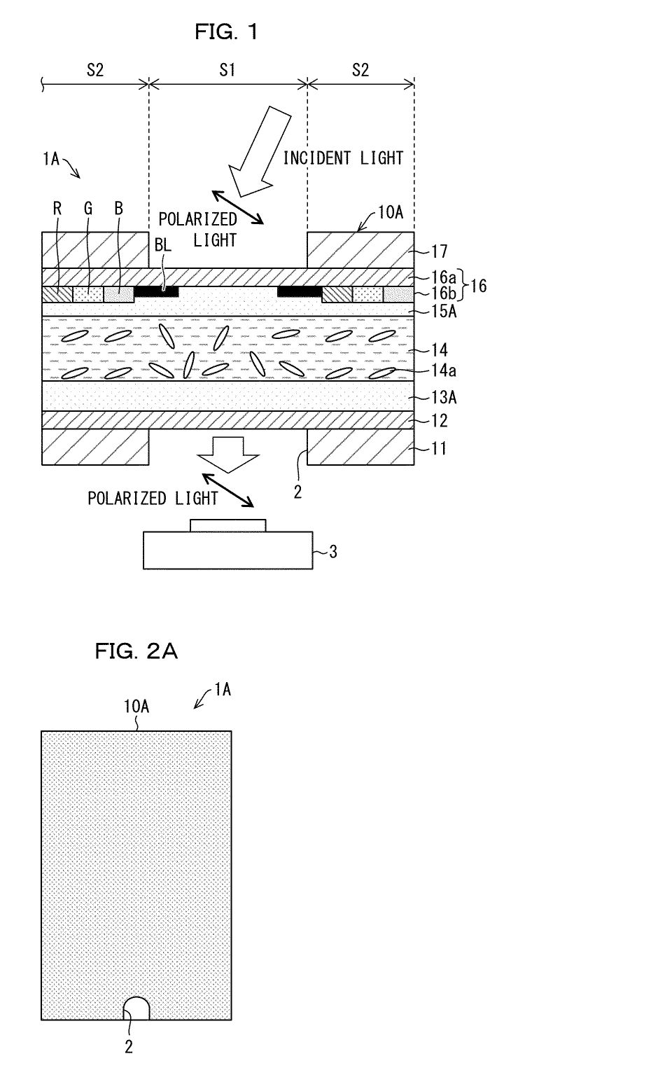

The following description will discuss an embodiment of the present invention with reference to FIGS. 1 through 3.

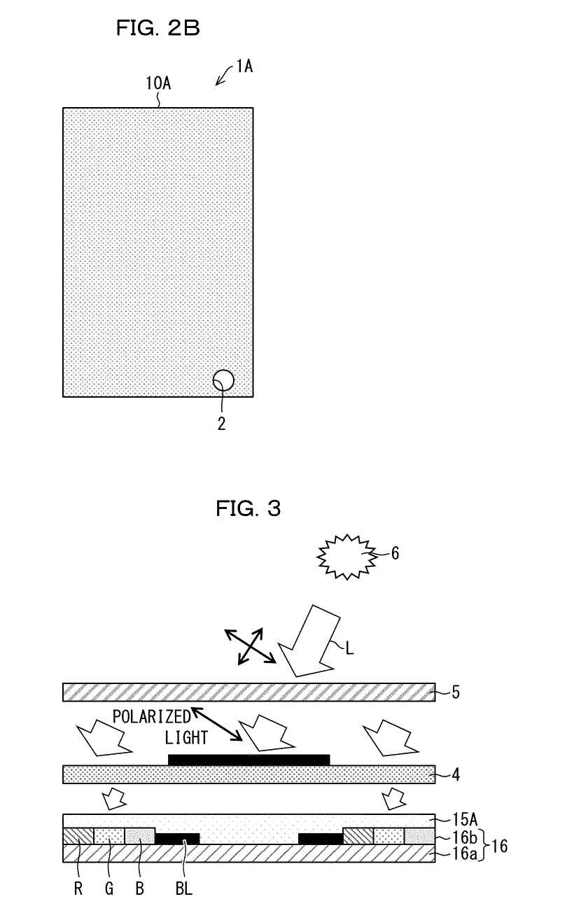

A configuration of a liquid crystal display device 1A in accordance with Embodiment 1 will be described below with reference to FIG. 1, FIG.2A and FIG. 2B. FIG. 1 is a cross-sectional view illustrating the configuration of the liquid crystal display device 1A in accordance with Embodiment 1. FIG. 2A is a front view illustrating a configuration of a liquid crystal panel 10A of the liquid crystal display device 1A in accordance with Embodiment 1. FIG. 2B is a front view illustrating a configuration of a variation of the liquid crystal panel 10A of the liquid crystal display device 1A in accordance with Embodiment 1.

The liquid crystal display device 1A in accordance with Embodiment 1 includes, for example, a mobile terminal such as a smartphone. As illustrated in FIG. 2A, the liquid crystal display device 1A includes a camera placement part 2 which serves as a display section and which is made by notching an edge part of the liquid crystal panel 10A. Note that the camera placement part 2 does not necessarily need to be provided so as to notch the edge part of the liquid crystal panel 10A. As illustrated in FIG. 2B, the camera placement part 2 can be provided by making a hole in the edge part of the liquid crystal panel 10A. As necessary, the camera placement part 2 can be provided at any part of the liquid crystal panel 10A.

Note, however, that the camera placement part 2 in accordance with Embodiment 1 is not of a type which is formed by notching a glass or making a hole in a glass. The camera placement part 2 is configured so that only in the camera placement part 2, for example, no pixel electrode, no black matrix, no color filter layer, and no wiring are present. This allows the camera placement part 2 to have a transmittance of nearly 100%, so that image capturing by a camera is not interfered with.

If a glass is notched or a hole is made in a glass, then a certain amount of sealing region and/or a certain structure for maintaining strength is/are necessary for (i) maintaining strength of adhesion between glass panels and (ii) preventing liquid crystals from leaking. According to Embodiment 1, however, the shape of a glass is untouched. This makes it unnecessary to provide any additional sealing or structures around the camera placement part 2. Therefore, there is no large frame region around the camera placement part 2, so that it is possible to efficiently provide the camera placement part 2 having a narrow frame. In addition, according to Embodiment 1, the camera placement part 2 is not separated from the rest of the display panel 10A by sealing. This causes a liquid crystal layer to fill not only an active area (display section) but also the camera placement part 2.

The liquid crystal display device 1A of Embodiment 1 is, specifically, configured so that the liquid crystal panel 10A serving as a display section includes a liquid crystal layer 14 including (A) a first part which (i) is located in a camera light transmissive region S1 through which light to enter a camera 3 of the camera placement part 2 passes and (ii) has an isotropic refractive index (not having retardation) and (B) a second part which (i) is located in a non-camera light transmissive region S2 which excludes the camera light transmissive region S1 and (ii) has an anisotropic refractive index (having retardation). In other words, (i) liquid crystal molecules 14a of first part of the liquid crystal layer 14 are not oriented and (ii) liquid crystal molecules 14a of parts of the liquid crystal layer 14, which parts correspond to the non-camera light transmissive region S2, are oriented.

Specifically, the liquid crystal panel 10A includes a polarizing plate 11, a thin film transistor (TFT) substrate 12, an alignment film 13A, the liquid crystal layer 14, an alignment film 15A, a color filter substrate 16, and a polarizing plate 17. Note that the camera 3 is provided so as to face the TFT substrate 12, and captures light entering through the color filter substrate 16, the alignment film 15A, the liquid crystal layer 14, the alignment film 13A, and the TFT substrate 12 in this order. In addition, an observer observing the display on the liquid crystal panel 10A is to observe a displayed image which excludes a part corresponding to the hole of the camera placement part 2.

The polarizing plate 11 is provided on a side of the TFT substrate 12, which side is opposite a side facing the liquid crystal layer 14. The polarizing plate 17 is provided on a side of the color filter substrate 16, which side is opposite a side facing the liquid crystal layer 14. The polarizing plates 11 and 17 are provided so that respective transmission axes of the polarizing plates 11 and 17 are orthogonal to each other.

The TFT substrate 12 is a substrate in which thin film transistors (TFTs) serving as switching elements (not illustrated) are provided in an array.

The color filter substrate 16 has a structure in which, for example, a filter layer 16b is provided on a glass substrate 16a. The filter layer 16b is configured so that a red filter R, a green filter G, a blue filter B, and a black matrix BL are provided in an array.

The liquid crystal layer 14 is provided between a pair of the TFT substrate 12 and the color filter substrate 16 which are provided so as to face each other. The liquid crystal layer 14 is filled with the liquid crystal molecules 14a.

The alignment film 13A is provided on the side of the TFT substrate 12, which side faces the liquid crystal layer 14. The alignment film 15A is provided on the side of the color filter substrate 16, which side faces the liquid crystal layer 14. The liquid crystal panel 10A in accordance with Embodiment 1 is, for example, a liquid crystal panel of a horizontal alignment type employing a horizontal electric field driving method. The respective parts of the alignment films 13A and 15A, which parts correspond to the non-camera light transmissive region S2 (which is a so-called active region), are each provided with an alignment function, so that when no voltage is applied, the liquid crystal molecules 14a in the parts are oriented in a certain direction parallel to a direction in which the TFT substrate 12 and the color filter substrate 16 extend. The alignment films 13A and 15A are each made of, for example, a polyimide resin. In an initial state, no alignment function is imparted to the alignment film 13A or to the alignment film 15A. Therefore, in a case of, for example, an Advanced Fringe Field Switching (AFFS) mode, an alignment function is imparted, by a rubbing treatment or optical alignment, to the alignment films 13A and 15A to each of which an alignment function is not imparted. This causes the liquid crystal molecules 14a to be oriented together in a direction in which an absorption axis of one of the polarizing plates 11 and 17 (which are orthogonal to each other) extends. This causes the alignment films 13A and 15A to be alignment function-imparted alignment films 13A and 15A.

Meanwhile, a liquid crystal display device 1A, in which light to enter a camera 3 passes through part of the liquid crystal panel 10A poses the following problem.

Specifically, the following problem-free cases cannot be completely achieved in actuality: (i) a case where light exiting a subject and then entering the camera 3 has no polarized light component at all and (ii) an optical system of the camera 3 has no polarized light component at all.

In general, even an optical system of the camera 3 has slight birefringence. This is because, for example, (i) polarization occurs at a refraction surface as a result of bending a lens or a prism and (ii) it is nearly impossible that light, which has passed through a material (including a coating) made of resin, has no birefringence. In addition, not only does direct light coming from the subject through a resin or the like has polarized light (polarization plane), but even light coming from a reflecting surface such as a water surface in scenery under sunlight also has polarized light (polarization plane).

Because liquid crystals having considerable birefringence effect are present between such light from a subject and a lens, a camera image obtained through the liquid crystals is considerably different from a camera image obtained without the liquid crystals. Specifically, the original contrast is not obtained. In addition, following problems, for example, may occur: (i) black crushing occurs to a part of an image, (ii) an originally colorless part is colored, and (iii) an image becomes colored so as to be different from a color of light to be visually recognized.

As in the case of the liquid crystal display device 1A in accordance with Embodiment 1, such problems, which do not occur in a case of notching a glass or making a hole in a glass of a liquid crystal panel 10A, are caused by a structure in which the liquid crystal panel 10A and the camera placement part 2 are not separated by sealing. These problems occurred in exchange for narrowing the frame of the camera part.

Meanwhile, these problems occur due to the birefringence effect of the liquid crystals, and can therefore be resolved by preventing the birefringence effect through preventing the liquid crystals from being oriented.

Therefore, according to the liquid crystal display device 1A of Embodiment 1, the liquid crystal panel 10A is configured so that the first part of the liquid crystal layer 14, which first part is located in the camera light transmissive region S1 (through which the light to enter the camera 3 passes), has an isotropic refractive index. Meanwhile, the second part of the liquid crystal layer 14, which second part is located in the non-camera light transmissive region S2 (excluding the camera light transmissive region S1), has an anisotropic refractive index. With this configuration, the first part of the liquid crystal layer 14, which is located in the camera light transmissive region S1, has an isotropic refractive index. This prevents the phenomenon of birefringence from occurring in the first part of the liquid crystal layer 14.

Meanwhile, the second part of the liquid crystal layer 14, which is located in the non-camera light transmissive region S2, has an anisotropic refractive index. This makes it possible to display an image as ordinarily by use of an anisotropic refractive index of the liquid crystal layer 14.

It is therefore possible to provide a liquid crystal display device 1A and a method of production thereof, each of which can prevent a camera image from being adversely affected by the birefringence of external polarized light which enters the camera 3 through the liquid crystal layer 14.

Note that a method of causing the first part of the liquid crystal layer 14, which part is located in the camera light transmissive region S1, to have an isotropic refractive index will be described below with reference to FIG. 3. FIG. 3 is a cross-sectional view illustrating an alignment function imparting process of causing, by use of optical alignment, an alignment film, to which an alignment function is not imparted (hereinafter such an alignment film will be referred to as “pre-impartation alignment film”), to become an alignment film to which an alignment function is imparted (such an alignment film will be hereinafter referred to as “post-impartation alignment film”).

In the initial state, the liquid crystal panel 10A of the liquid crystal display device 1A in accordance with Embodiment 1 is configured so that the alignment films 13A and 15A, to each of which an alignment function is not yet imparted, are provided on the respective liquid crystal layer 14-sides of the TFT substrate 12 and the color filter substrate 16. By rubbing or optical alignment, the alignment films 13A and 15A, to each of which an alignment function is not yet imparted, will be alignment films 13A and 15A to each of which an alignment function is imparted.

According to Embodiment 1, optical alignment is carried out so as to irradiate the pre-impartation alignment films 13A and 15A with ultraviolet light from above.

Specifically, as illustrated in FIG. 3, the following is carried out before the TFT substrate 12 and the color filter substrate 16 are combined together in the process of producing the liquid crystal panel 10A: the pre-impartation alignment film 13A applied to a glass surface irradiated with ultraviolet light L which is illuminated from ultra violet (UV) light source 6 through a polarizing filter 5. According to Embodiment 1, the irradiation by the ultraviolet light L is carried out while the camera light transmissive region S1 is covered with a photo mask 4 serving as a shielding plate.

Consequently, (i) an alignment function is imparted to a part of the pre-impartation alignment film 13A, which part is located in the non-camera light transmissive region S2 and (ii) an alignment function is not imparted to the other part of the pre-impartation alignment film 13A, which part is located in the camera light transmissive region S1.

Note that FIG. 3 illustrates an alignment function imparting process in which an alignment function is imparted to a part of the pre-impartation alignment film 15A, which part faces the color filter substrate 16. An alignment function imparting process is likewise carried out so as to impart an alignment function to a part of the pre-impartation alignment film 13A, which part faces the TFT substrate 12.

Subsequently, the TFT substrate 12, which has the post-impartation alignment film 13A, and the color filter substrate 16, which has the post-impartation alignment film 15A, are each coated with a sealing material. Then, liquid crystals are dropped. Then, the TFT substrate 12 and the color filter substrate 16 are combined together. This causes the liquid crystal molecules 14a to be sealed between the TFT substrate 12 and the color filter substrate 16, so that the liquid crystal molecules 14a of the liquid crystal layer 14 are oriented.

According to the liquid crystal display device 1A of Embodiment 1, light to enter the camera 3 thus passes through a part of the liquid crystal panel 10A serving as a display section. Then, the liquid crystal panel 10A is configured so that (i) the first part of the liquid crystal layer 14, which is located in the camera light transmissive region S1 (through which the light to enter the camera 3 passes), has an isotropic refractive index and (ii) the second part of the liquid crystal layer 14, which part is located in the non-camera light transmissive region S2 (which excludes the camera light transmissive region S1), has an anisotropic refractive index.

A liquid crystal display device 1A production method in accordance with Embodiment 1 is a method of producing a liquid crystal display device 1A which includes the liquid crystal panel 10A having a part through which the light to enter a camera 3 passes. The method including the steps of: (a) causing a first part of the liquid crystal layer 14 of the liquid crystal panels 10A, which first part is located in a camera light transmissive region S1 allowing the light to enter the camera 3 to pass therethrough, to have an isotropic refractive index; and (b) causing a second part of the liquid crystal layer 14 of the liquid crystal panels 10A, which second part is located in a non-camera light transmissive region S2 excluding the camera light transmissive region S1, to have an anisotropic refractive index.

With this configuration, the first part of the liquid crystal layer 14, which is located in the camera light transmissive region S1, has an isotropic refractive index. This prevents the phenomenon of birefringence from occurring in the first part of the liquid crystal layer 14.

Meanwhile, the second part of the liquid crystal layer 14, which is located in the non-camera light transmissive region S2, has an anisotropic refractive index. This makes it possible to display an image as ordinarily by use of an anisotropic refractive index of the liquid crystal layer 14.

It is therefore possible to provide a liquid crystal display device 1A and a method of production thereof, each of which can prevent a camera image from being adversely affected by the birefringence of external polarized light which enters the camera 3 through the liquid crystal layer 14.

Conventionally, as in the case of the liquid crystal display device 1A in accordance with Embodiment 1, the adverse effects of birefringence, which do not occur in a case of notching a glass or making a hole in a glass of a liquid crystal panel 10A, are caused by a structure in which the liquid crystal panel 10A and the camera placement part 2 are not separated by sealing. These problems occurred in exchange for narrowing the frame of the camera part. However, with the configuration of the liquid crystal display device 1A in accordance with Embodiment 1, it is possible to simultaneously (i) resolve the adverse effects of birefringence and (ii) achieve narrowing of the frame of the liquid crystal panel 10A.

According to the liquid crystal display device 1A of Embodiment 1, the liquid crystal panel 10A is configured so that (i) the TFT substrate 12 and the color filter substrate 16 face each other with the liquid crystal layer 14 present therebetween, (ii) the TFT substrate 12 is provided with a pre-impartation part and a post-impartation part of the alignment film 13A, and (iii) the color filter substrate 16 is provided with a pre-impartation part and a post-impartation part of the alignment film 15A. Then, (i) the non-camera light transmissive region S2 is an alignment region corresponding to the second part of the liquid crystal layer 14, in which the liquid crystal molecules 14a are oriented due to the post-impartation alignment films 13A and 15A and (ii) the camera light transmissive region S1 is a non-alignment region corresponding to the first part of the liquid crystal layer 14, in which the liquid crystal molecules 14a are non-oriented due to the pre-impartation alignment films 13A and 15A.

According to the liquid crystal display device 1A production method of Embodiment 1, the liquid crystal panel 10A is configured so that (i) the TFT substrate 12 and the color filter substrate 16 face each other with the liquid crystal layer 14 present therebetween, (ii) the TFT substrate 12 is provided with a pre-impartation part and a post-impartation part of the alignment film 13A, and (iii) the color filter substrate 16 is provided with a pre-impartation part and a post-impartation part of the alignment film 15A. Then, (i) the non-camera light transmissive region S2 is an alignment region corresponding to the second part of the liquid crystal layer 14, in which the liquid crystal molecules 14a are oriented due to the post-impartation alignment films 13A and 15A and (ii) the camera light transmissive region S1 is a non-alignment region corresponding to the first part of the liquid crystal layer 14, in which the liquid crystal molecules 14a are non-oriented due to the pre-impartation alignment films 13A and 15A.

Therefore, in the second part located in the non-camera light transmissive region S2, the post-impartation alignment films 13A and 15A are present. This causes the liquid crystal molecules 14a in the second part of the liquid crystal layer 14 to be oriented, so that the second part has an anisotropic refractive index. This makes it possible to display, at the second part located in the non-camera light transmissive region S2, an image as ordinarily by use of an anisotropic refractive index of the liquid crystal layer 14.

Meanwhile, in the first part located in the camera light transmissive region S1, the pre-impartation alignment films 13A and 15A are present. This means that the camera light transmissive region S1 is a non-alignment region in which the liquid crystal molecules 14a are not oriented. This causes the first part of the liquid crystal layer 14 to have an isotropic refractive index, and therefore prevents the phenomenon of birefringence from occurring in the first part even in a case where external polarized light enters the liquid crystal layer 14.

Therefore, in a case where (i) the TFT substrate 12 is provided with the alignment film 13A and (ii) the color filter substrate 16 is provided with the alignment film 15A, it is possible to provide a liquid crystal display device 1A and a method of production thereof, each of which can prevent a camera image from being adversely affected by the birefringence of external polarized light which enters the camera 3 through the liquid crystal layer 14.

According to the liquid crystal display device 1A production method of Embodiment 1, post-impartation alignment films 13A and 15A are formed as follows: (i) the TFT substrate 12 is provided with a pre-impartation alignment film 13A and the color filter substrate 16 is provided with a pre-impartation alignment film 15A and then (ii) the pre-impartation alignment films 13A and 15A are irradiated with ultraviolet light L from above while the camera light transmissive region S1 is covered with the photo mask 4 serving as a shielding plate.

Consequently, in the first part located in the camera light transmissive region S1, no alignment function is imparted to the pre-impartation alignment films 13A and 15A. It is therefore possible easily cause the liquid crystal molecules 14a in the second part of the liquid crystal layer 14 (located in the non-camera light transmissive region S2 excluding the camera light transmissive region S1) to be oriented without causing the liquid crystal molecules 14a in the first part of the liquid crystal layer 14 (located in the camera light transmissive region S1) to be oriented.

### Embodiment 2

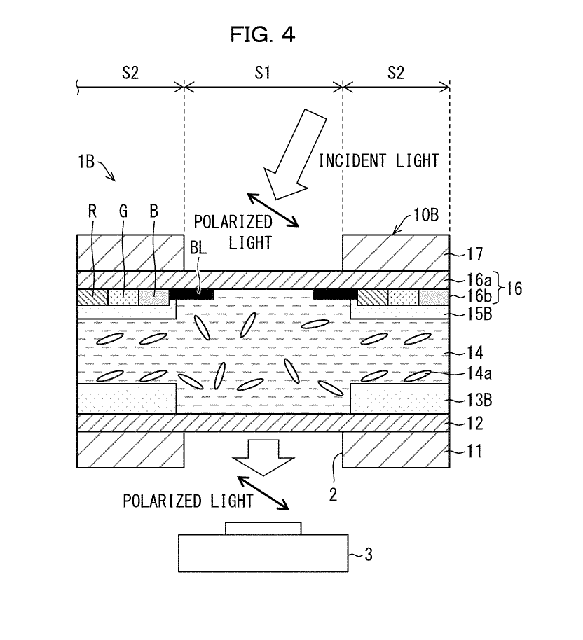

The following description will discuss another embodiment of the present invention with reference to FIG. 4. Note that features of Embodiment 2 other than those described in Embodiment 2 are identical to those of Embodiment 1. For convenience, members having functions identical to those illustrated in the drawings of Embodiment 1 are given identical reference signs, and their descriptions are omitted.

As illustrated in FIG. 4, a configuration of a liquid crystal display device 1B in accordance with Embodiment 2 is different from the configuration of the liquid crystal display device 1A in accordance with Embodiment 1 in that alignment films 13B and 15B are not present in a part located in a camera light transmissive region S1 of a liquid crystal panel 10B.

The configuration of the liquid crystal display device 1B in accordance with Embodiment 2 will be described below with reference to FIG. 4. FIG. 4 is a cross-sectional view illustrating the configuration of the liquid crystal display device 1B in accordance with Embodiment 2.

As illustrated in FIG. 4, the liquid crystal panel 10B of the liquid crystal display device 1B is configured so that (A) an alignment film 13B is (i) present on a part on a TFT substrate 12, which part is located in a non-camera light transmissive region S2 and (ii) absent on a part on the TFT substrate 12, which part is located in a camera light transmissive region S1 and (B) an alignment film 15B is (i) present on a part on a color filter substrate 16, which part is located in the non-camera light transmissive region S2 and (ii) absent on a part on the color filter substrate 16, which part is located in the camera light transmissive region S1.

A method below as a method different from the method described in Embodiment 1 can be employed in order to configure the liquid crystal panel 10B so that (i) a first part of the liquid crystal layer 14, which first part is located in the camera light transmissive region S1 (through which the light to enter a camera 3 passes), has an isotropic refractive index and (ii) a second part of the liquid crystal layer 14, which second part is located in the non-camera light transmissive region S2 (which excludes the camera light transmissive region S1), has an anisotropic refractive index.

Specifically, with the liquid crystal display device 1B and a method of production thereof, the TFT substrate 12 and the color filter substrate 16 in the liquid crystal panel 10B, which face each other with the liquid crystal layer 14 present therebetween, can be configured so that (i) the post-impartation alignment films 13B and 15B are provided in the second part located in the non-camera light transmissive region S2 and (ii) the post-impartation alignment films 13B and 15B are not provided in the first part located in the camera light transmissive region S1.

In a case where the alignment films 13B and 15B are printed during production of the liquid crystal display device 1B, the first parts of the TFT substrate 12 and the color filter substrate 16 are not coated with the pre-impartation alignment films 13B and 15B.

Consequently, even in a case where the pre-impartation alignment films 13B and 15B are subjected to an alignment function imparting process by irradiation with, for example, ultraviolet light L from above the TFT substrate 12 and the color filter substrate 16, liquid crystal molecules 14a in the first parts are not oriented in one direction but are provided randomly, because the alignment films 13B and 15B are not provided on the first parts located in the camera light transmissive region S1.

Consequently, even in a case where, unlike Embodiment 1, the camera light transmissive region S1 is not covered with a photo mask 4, it is still possible to prevent only the liquid crystal molecules 14a in the first part located in the camera light transmissive region S1 from being oriented. It is therefore possible to simplify the steps in the alignment process.

[Recap]

A liquid crystal display device (1A, 1B) in accordance with Aspect 1 of the present invention is a liquid crystal display device including: a display section (liquid crystal panels 10A, 10B) including a liquid crystal layer 14; and a camera 3, the liquid crystal display device being configured so that light to enter the camera passes through a part of the display section, the liquid crystal layer 14 of the display section (liquid crystal panels 10A, 10B) having (a) a first part being located in a camera light transmissive region S1 and having an isotropic refractive index, which camera light transmissive region S1 allows the light to enter the camera 3 to pass therethrough and (b) a second part being located in a non-camera light transmissive region S2 and having an anisotropic refractive index, which non-camera light transmissive region S2 excludes the camera light transmissive region S1.

A liquid crystal display device (1A, 1B) production method in accordance with Aspect 4 of the present invention is a method of producing a liquid crystal display device, the liquid crystal display device including: a display section (liquid crystal panels 10A, 10B) including a liquid crystal layer 14; and a camera 3, the liquid crystal display device being configured so that light to enter the camera 3 passes through a part of the display section (liquid crystal panels 10A, 10B), the method including the steps of: (a) causing a first part of the liquid crystal layer 14 of the display section (liquid crystal panels 10A, 10B), which first part is located in a camera light transmissive region S1 allowing the light to enter the camera 3 to pass therethrough, to have an isotropic refractive index; and (b) causing a second part of the liquid crystal layer 14 of the display section (liquid crystal panels 10A, 10B), which second part is located in a non-camera light transmissive region S2 excluding the camera light transmissive region S1, to have an anisotropic refractive index.

In a case of a liquid crystal display device in which light to enter a camera passes through a part of a display section, the following is true: if light entering the camera has a polarized light component as with, for example, light reflected by a water surface, then the phenomenon of birefringence occurs in a part of a liquid crystal layer, which part is located in a camera light transmissive region. This is because the liquid crystal layer has an anisotropic refractive index. This leads to a problem(s). For example, a camera image may be colored, light-blocked, or doubled.

In accordance with an aspect of the present invention, therefore, the display section is configured so that (i) the first part of the liquid crystal layer, which is located in the camera light transmissive region (through which the light to enter the camera passes), has an isotropic refractive index and (ii) the second part of the liquid crystal layer, which part is located in the non-camera light transmissive region (which excludes the camera light transmissive region), has an anisotropic refractive index. With this configuration, the first part of the liquid crystal layer, which is located in the camera light transmissive region, has an isotropic refractive index. This prevents the phenomenon of birefringence from occurring in the first part of the liquid crystal layer.

Meanwhile, the second part of the liquid crystal layer, which is located in the non-camera light transmissive region, has an anisotropic refractive index. This makes it possible to display an image as ordinarily by use of an anisotropic refractive index of the liquid crystal layer.

It is therefore possible to provide a liquid crystal display device and a method of production thereof, each of which can prevent a camera image from being adversely affected by the birefringence of external polarized light which enters the camera through the liquid crystal layer.

The liquid crystal display device 1A in accordance with Aspect 2 of the present invention can be configured so as to further include: substrates (TFT substrate 12, color filter substrate 16) which are provided so as to face each other with the liquid crystal layer 14 of the display section (liquid crystal panel 10A) present therebetween and which are provided with (i) respective post-impartation alignment films (alignment films 13A and 15A) to which an alignment function is imparted and (ii) respective pre-impartation alignment films (alignment films 13A and 15A) to which an alignment function is not imparted, the non-camera light transmissive region S2 being an alignment region corresponding to the second part in which liquid crystal molecules 14a are oriented due to the post-impartation alignment films (alignment films 13A and 15A), and the camera light transmissive region S1 being a non-alignment region corresponding to the first part in which liquid crystal molecules 14a are non-oriented due to the pre-impartation alignment films (alignment films 13A and 15A).

The liquid crystal display device 1A production method in accordance with Aspect 5 of the present invention is configured so that the liquid crystal display device 1A further includes: substrates (TFT substrate 12, color filter substrate 16) which are provided so as to face each other with the liquid crystal layer 14 of the display section (liquid crystal panel 10A) present therebetween, the method further includes the steps of: (c) forming, on the substrates (TFT substrate 12, color filter substrate 16), (i) respective post-impartation alignment films (alignment films 13A and 15A) to which an alignment function is imparted and (ii) respective pre-impartation alignment films (alignment films 13A and 15A) to which an alignment function is not imparted, so that (i) the non-camera light transmissive region S2 is an alignment region corresponding to the second part in which liquid crystal molecules 14a are oriented due to the post-impartation alignment films (alignment films 13A and 15A) and (ii) the camera light transmissive region S1 is a non-alignment region corresponding to the first part in which liquid crystal molecules 14a are non-oriented due to the pre-impartation alignment films (alignment films 13A and 15A).

In accordance with an aspect of the present invention, the substrates, which are provided so as to face each other with the liquid crystal layer of the display section present therebetween, are provided with (i) respective post-impartation alignment films and (ii) respective pre-impartation alignment films. Then, (i) the non-camera light transmissive region is an alignment region corresponding to the second part of the liquid crystal layer, in which the liquid crystal molecules are oriented due to the post-impartation alignment films and (ii) the camera light transmissive region is a non-alignment region corresponding to the first part of the liquid crystal layer, in which the liquid crystal molecules are non-oriented due to the pre-impartation alignment films.

Therefore, in the second part located in the non-camera light transmissive region, the post-impartation alignment films are present. This causes the liquid crystal molecules in the second part of the liquid crystal layer to be oriented, so that the second part has an anisotropic refractive index. This makes it possible to display, at the second part located in the non-camera light transmissive region, an image as ordinarily by use of an anisotropic refractive index of the liquid crystal layer.

Meanwhile, in the first part located in the camera light transmissive region, the pre-impartation alignment films are present. This means that the camera light transmissive region is a non-alignment region in which the liquid crystal molecules are not oriented. This causes the first part of the liquid crystal layer to have an isotropic refractive index, and therefore prevents the phenomenon of birefringence from occurring in the first part located in the camera light transmissive region even in a case where external polarized light enters the liquid crystal layer.

Therefore, in a case where the substrate are provided with the alignment films, it is possible to provide a liquid crystal display device and a method of production thereof, each of which can prevent a camera image from being adversely affected by the birefringence of external polarized light which enters the camera through the liquid crystal layer.

The liquid crystal display device 1A production method in accordance with Aspect 6 of the present invention is preferably configured so that in the step (c), the pre-impartation alignment films (alignment films 13A and 15A) are formed on the respective substrates (TFT substrate 12, color filter substrate 16), and then the post-impartation alignment films (alignment films 13A and 15A) are formed by irradiating the pre-impartation alignment films (alignment films 13A and 15A) with ultraviolet light from above while the camera light transmissive region S1 is covered with a shielding plate (photo mask 4).

Alignment films are provided on the respective substrates. In an initial state, the alignment films are pre-impartation alignment films. It is therefore necessary to impart an alignment function to the alignment films. Hence, in an aspect of the present invention, optical alignment is carried out. In this case, the pre-impartation alignment films are provided on the respective substrates, and then the pre-impartation alignment films are irradiated with ultraviolet light from above while the camera light transmissive region is covered with a shielding plate. Consequently, in the first part located in the camera light transmissive region, no alignment function is imparted to the pre-impartation alignment films.

It is therefore possible easily cause the liquid crystal molecules in the second part of the liquid crystal layer (located in the non-camera light transmissive region excluding the camera light transmissive region) to be oriented without causing the liquid crystal molecules in the first part of the liquid crystal layer (located in the camera light transmissive region) to be oriented.

The liquid crystal display device 1B in accordance with Aspect 3 of the present invention can be configured to further include: substrates (TFT substrate 12, color filter substrate 16) which are provided so as to face each other with the liquid crystal layer 14 of the display section (liquid crystal panel 10B) present therebetween and which have (i) respective second parts that correspond to the non-camera light transmissive region S2 and that are provided with respective post-impartation alignment films (alignment films 13B and 15B) to which an alignment function is imparted and (ii) respective first parts that correspond to the camera light transmissive region S1 and that are not provided with alignment films (alignment films 13B and 15B).

The liquid crystal display device 1B production method in accordance with Aspect 7 of the present invention can be configured so that the liquid crystal display device 1B further includes: substrates (TFT substrate 12, color filter substrate 16) which are provided so as to face each other with the liquid crystal layer 14 of the display section (liquid crystal panel 10B) present therebetween, and the method further includes the step of: (d) forming post-impartation alignment films (alignment films 13B and 15B) on respective second parts of the substrates (TFT substrate 12, color filter substrate 16), which second parts correspond to the non-camera light transmissive region S2, while not forming alignment films (alignment films 13B and 15B) on respective first parts of the substrates (TFT substrate 12, color filter substrate 16), which first parts correspond to the camera light transmissive region S1, the post-impartation alignment films (alignment films 13B and 15B) being films to which an alignment function is imparted.

Consequently, even in a case where the alignment films are subjected to an alignment function imparting process by irradiation with, for example, ultraviolet light from above the substrates, liquid crystal molecules in the first parts are not oriented, because the alignment films are not provided on the first parts located in the camera light transmissive region.

Consequently, even in a case where the camera light transmissive region is not covered with a shielding plate, it is still possible to prevent only the liquid crystal molecules in the first part located in the camera light transmissive region from being oriented. It is therefore possible to simplify the steps in the alignment process.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1A, 1B Liquid crystal display device

2 Camera placement part

3 Camera

4 Photo mask (shielding plate)

5 Polarizing filter

6 UV light source

10A, 10B Liquid crystal panel (display section)

11, 17 Polarizing plate

12 TFT substrate (substrate)

13A, 13B Alignment film

14 Liquid crystal layer

14a Liquid crystal molecule

15A, 15B Alignment film

16 Color filter substrate (substrate)

16a Glass substrate

16b Filter layer

S1 Camera light transmissive region

S2 Camera light non-transmissive region

1. A liquid crystal display device comprising:
a display section including a liquid crystal layer; and
a camera,
the liquid crystal display device being configured so that light to enter the camera passes through a part of the display section,
the liquid crystal layer of the display section having (a) a first part being located in a camera light transmissive region and having an isotropic refractive index, which camera light transmissive region allows the light to enter the camera to pass therethrough and (b) a second part being located in a non-camera light transmissive region and having an anisotropic refractive index, which non-camera light transmissive region excludes the camera light transmissive region.

2. The liquid crystal display device as set forth in claim 1, further comprising:
substrates which are provided so as to face each other with the liquid crystal layer present therebetween and which are provided with (i) respective post-impartation alignment films to which an alignment function is imparted and (ii) respective pre-impartation alignment films to which an alignment function is not imparted,
the non-camera light transmissive region being an alignment region corresponding to the second part in which liquid crystal molecules are oriented due to the post-impartation alignment films, and
the camera light transmissive region being a non-alignment region corresponding to the first part in which liquid crystal molecules are non-oriented due to the pre-impartation alignment films.

3. The liquid crystal display device as set forth in claim 1, further comprising:
substrates which are provided so as to face each other with the liquid crystal layer present therebetween and which have (i) respective second parts that correspond to the non-camera light transmissive region and that are provided with respective post-impartation alignment films to which an alignment function is imparted and (ii) respective first parts that correspond to the camera light transmissive region and that are not provided with alignment films.

4. A method of producing a liquid crystal display device, said liquid crystal display device comprising:
a display section including a liquid crystal layer; and
a camera,
the liquid crystal display device being configured so that light to enter the camera passes through a part of the display section,
said method comprising the steps of:
(a) causing a first part of the liquid crystal layer of the display section, which first part is located in a camera light transmissive region allowing the light to enter the camera to pass therethrough, to have an isotropic refractive index; and
(b) causing a second part of the liquid crystal layer of the display section, which second part is located in a non-camera light transmissive region excluding the camera light transmissive region, to have an anisotropic refractive index.

5. The method as set forth in claim 4, wherein
the liquid crystal display device further comprises:
substrates which are provided so as to face each other with the liquid crystal layer present therebetween, and
the method further comprises the steps of:
(c) forming, on the substrates, (i) respective post-impartation alignment films to which an alignment function is imparted and (ii) respective pre-impartation alignment films to which an alignment function is not imparted, so that
(i) the non-camera light transmissive region is an alignment region corresponding to the second part in which liquid crystal molecules are oriented due to the post-impartation alignment films and (ii) the camera light transmissive region is a non-alignment region corresponding to the first part in which liquid crystal molecules are non-oriented due to the pre-impartation alignment films.

6. The method as set forth in claim 5, wherein
in the step (c), the pre-impartation alignment films are formed on the respective substrates, and then the post-impartation alignment films are formed by irradiating the pre-impartation alignment films with ultraviolet light from above while the camera light transmissive region is covered with a shielding plate.

7. The method as set forth in claim 4, wherein
the liquid crystal display device further comprises:
substrates which are provided so as to face each other with the liquid crystal layer present therebetween, and
the method further comprises the step of:
(d) forming post-impartation alignment films on respective second parts of the substrates, which second parts correspond to the non-camera light transmissive region, while not forming alignment films on respective first parts of the substrates, which first parts correspond to the camera light transmissive region, the post-impartation alignment films being films to which an alignment function is imparted.
